(19) United States
(12) Patent Application Publication
(10) Pub. No.: US 2022/0307941 A1
(43) Pub. Date: Sep. 29, 2022

(54) METHOD FOR EARLY DETECTION AND PROGNOSIS OF WHEEL BEARING FAULTS USING WHEEL SPEED SENSOR

(71) Applicant: GM Global Technology Operations LLC, Detroit, MI (US)

(72) Inventors: Graeme R. Garner, York (CA); Hossein Sadjadi, Markham (CA); Samba Drame, Toronto (CA); Griffin L. Tanner, Toronto (CA)

(21) Appl. No.: 17/212,215

(22) Filed: Mar. 25, 2021

(51) Int. Cl. G01M 13/045

(52) U.S. Cl. CPC G01M 13/045

(57) ABSTRACT

A method for early detection and prognosis of wheel bearing faults in a motor vehicle includes one or more of the following: obtaining a wheel speed of a wheel with a sensor in combination with an encoder ring, the sensor generating a signal, the wheel including a bearing that enables rotational movement of the wheel; pre-processing the signal from the sensor; and post- processing an output of the pre-processed signal to generate a bearing fault signature of the bearing.

### INTRODUCTION

The present disclosure relates to monitoring wheel bearings. More specifically, the present disclosure relates to early detection and prognosis of wheel bearing faults using wheel speed sensors.

Bearings such as, for example, utilized in wheels for motor vehicles may experience faults when in use. Known methods for detection of a bearing fault often involve an operator of the motor vehicle who discerns audible or tactile data to infer a potential fault. Thus, the ability to detect a bearing fault in many cases is dependent upon sensory capabilities and skill level of an operator. Incomplete bearing fault detection is exacerbated by inattention or absence of the vehicle operator. Moreover, monitoring of bearings in motor vehicles is not typically associated with on-vehicle monitoring systems.

Thus, while current systems and methods to monitor bearing faults achieve their intended purpose, there is a need for a new and improved system and method on the vehicle for early detection of bearing faults.

### SUMMARY

According to several aspects, a method for early detection and prognosis of wheel bearing faults in a motor vehicle includes one or more of the following: obtaining a wheel speed of a wheel with a sensor in combination with an encoder ring, the sensor generating a signal, the wheel including a bearing that enables rotational movement of the wheel; pre-processing the signal from the sensor; and post-processing an output of the pre-processed signal to generate a bearing fault signature of the bearing.

In an additional aspect of the present disclosure, pre- processing the signal from the sensor includes a phase domain transformation.

In another aspect of the present disclosure, pre-processing the signal from the sensor includes filtering the signal.

In another aspect of the present disclosure, pre-processing the signal from the sensor includes identifying signals that are sufficient for bearing health assessment.

In another aspect of the present disclosure, pre-processing the signal includes short time Fourier transformation (STFT).

In another aspect of the present disclosure, output from the STFT is combined with output from an enabler.

In another aspect of the present disclosure, post-processing generates a normalized wheel speed frequency spectrum.

In another aspect of the present disclosure, the normalized wheel speed frequency spectrum identifies the bearing fault signature at critical frequencies related to the geometry of the bearing including at least one of the ball pass frequency outer, ball pass frequency inner, and ball spin frequency.

In another aspect of the present disclosure, post-processing includes at least one of spectrum filtering, spectrum normalization, bearing critical frequency harmonics analysis, and regression analysis.

According to several aspects, a method for early detection and prognosis of bearing faults in a rotational member includes one or more of the following: obtaining a rotational speed of the rotational member with a sensor in combination with an encoder ring, the sensor generating a signal, the rotational member including a bearing that enables rotational movement of the wheel; pre-processing the signal from the sensor, pre-processing the signal from the sensor including a phase domain transformation and a short time Fourier transformation (STFT); and post-processing an output of the pre- processed signal to generate a bearing fault signature of the bearing, post- processing generating a normalized rotational speed frequency spectrum, the normalized rotational speed frequency spectrum identifying the bearing fault signature at critical frequencies.

In another aspect of the present disclosure, pre-processing the signal from the sensor includes filtering the signal.

In another aspect of the present disclosure, pre-processing the signal from the sensor includes identifying signals that are sufficient for bearing health assessment.

In another aspect of the present disclosure, output from the STFT is combined with output from an enabler.

In another aspect of the present disclosure, the normalized wheel speed frequency spectrum is associated with the geometry of the bearing.

In another aspect of the present disclosure, post-processing includes at least one of spectrum filtering, spectrum normalization, bearing critical frequency harmonics analysis, and regression analysis.

According to several aspects, a system for early detection and prognosis of wheel bearing faults in a motor vehicle includes a bearing positioned on the wheel, the bearing enabling rotational movement of the wheel, an encoder ring positioned on the wheel, a sensor positioned proximal to the wheel, the sensor in combination with the encoder ring detecting a wheel speed of the wheel, and a controller in communication with the sensor. The controller includes instructions to pre-process the signal from the sensor, pre- processing the signal from the sensor including a phase domain transformation and a short time Fourier transformation (STFT), and post-process the pre- processed signal to generate a bearing fault signature of the bearing, post- processing generating a normalized wheel speed frequency spectrum, the normalized wheel speed frequency spectrum identifying the bearing fault signature at critical frequencies.

In another aspect of the present disclosure, output from the STFT is combined with output from an enabler.

In another aspect of the present disclosure, the normalized wheel speed frequency spectrum is associated with the geometry of the bearing.

In another aspect of the present disclosure, post-processing includes at least one of spectrum filtering, spectrum normalization, bearing critical frequency harmonics analysis, and regression analysis.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagram of a system for early detection and prognosis of wheel bearing faults in a motor vehicle according to an exemplary embodiment;

FIG. 2 is an expanded view of the system shown in FIG. 1 according to an exemplary embodiment;

FIG. 3A is a plot of a speed measurement of a wheel with the system shown in FIG. 2 is according to an exemplary embodiment;

FIG. 3B is a plot of frequency peaks generated with the system shown in FIG. 2 according to an exemplary embodiment;

FIG. 3C is a plot of fault signatures generated with the system shown in FIG. 2 according to an exemplary embodiment;

FIG. 4 illustrates a transformation of data generated with the system shown in FIG. 2 from the time domain to the phase domain; and

FIG. 5 is a block diagram of a process for short time Fourier transformation with the system shown in FIG. 2.

### DETAILED DESCRIPTION

The following description is merely exemplary in nature and is not intended to limit the present disclosure, application, or uses.

Referring to FIG. 1, there is shown an overview of a system 10 for detecting bearing faults in a bearing 13 of a wheel hub assembly for a motor vehicle, which includes, in various implementations, the bearing 13, a brake rotor 12, an encoder ring 14 and a sensor 16. The bearing 13 enables friction-free or near friction-free rotational movement of the wheel hub assembly positioned, for example, at the corners of the motor vehicle. The encoder ring 14 is mounted, for example, to an inner race of the bearing 13 so that the encoder ring 14 rotates with the brake rotor 12. The encoder ring 14 has a set of equally spaced teeth about its circumference and a sensor 16 is positioned proximal to the brake rotor 12. The sensor 16 monitors a fixed point on the circumference of the wheel hub and detects whenever a new tooth of the encoder ring 14 has passed by the sensor 16. In some arrangements, the encoder ring 14 teeth are made from a magnetic material, and the sensor 16 detects rising and falling edges in a magnetic strength signal. Wheel speed is calculated from two internal signals recorded by the sensor 16, namely the pulse counter and timestamp. The sensor 16 has an internal clock with microsecond accuracy. Each time a new tooth of the encoder ring 14 is detected by the sensor 16, the pulse counter signal is incremented by one and the current time on the internal clock is saved as the timestamp. Together, these signals are utilized to calculate wheel speed via a simple discrete derivative.

The system 10 further includes a phase domain transform component 18 that receives wheel speed signals from the sensor 16. An enabler 20 receives information from the phase domain transform component 18 and transmits information to a short time Fourier transform (STFT) component 22. A component 24 normalizes the peaks from the data of the Fourier transform component 22. The component 24 further provides a fault signature based on the normalized peaks at bearing critical frequency, such as the ball pass frequency outer (BPFO), ball pass frequency inner and ball spin frequency, which is derived from the geometry of the bearing 13.

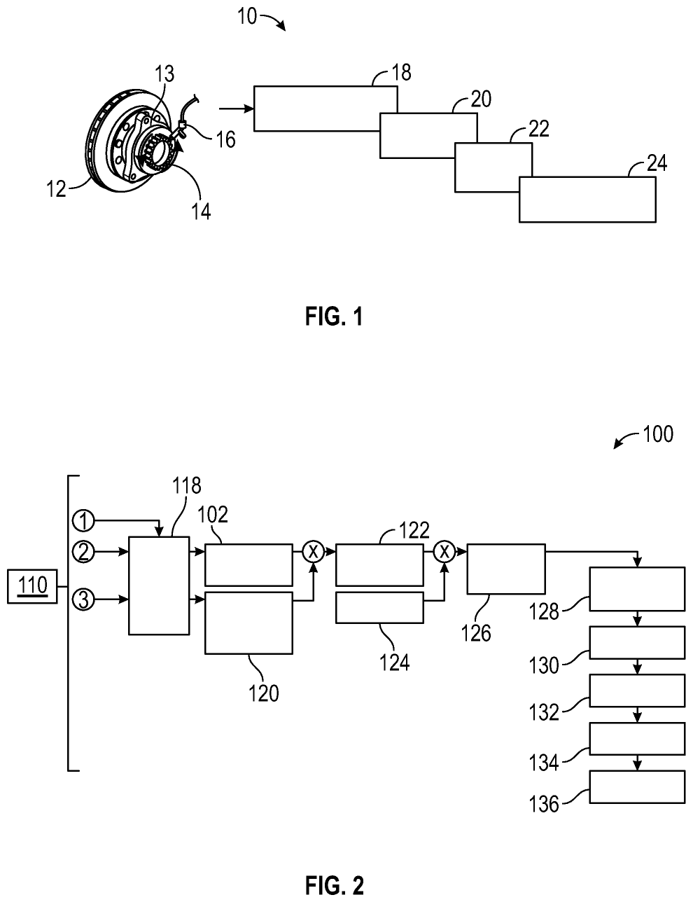

Turning now to FIG. 2, there is shown a system 100 that is a more detailed view of the system 10 described above. The system 100 receives instructions from a controller 110. The term “controller” and related terms, such as electronic control unit, to one or various combinations of Application Specific Integrated Circuit(s) (ASIC), electronic circuit(s), central processing unit(s), for example, microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions. Routines may be executed at regular intervals. Alternatively, routines may be executed in response to occurrence of a triggering event. Communication between the controller 110, the sensor 16 and the system 100 is accomplished in various arrangements using a direct wired point-to-point link, a networked communication bus link, a wireless link or another suitable communication link. Communication includes exchanging data signals in suitable form, including, for example, electrical signals via a conductive medium, electromagnetic signals via air, optical signals via optical waveguides, and the like. The data signals may include discrete, analog or digitized analog signals representing inputs from sensors, actuator commands, and communication between controllers. The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium.

The system 100 includes pre-processing components and post-processing components. The pre-processing components include a phase domain transform module 118, a high-pass filter 102, a first enabler 120, a STFT module 122, a second enabler 124, and an integer order filter 126. The post-processing components include a spectrum filter 128, a spectrum normalizer 130, a module 132 that determines the harmonics of the bearing critical frequencies in the normalized wheel speed spectrum, and a regression analysis module 134. The output of the post-processing components is a bearing fault signature 136.

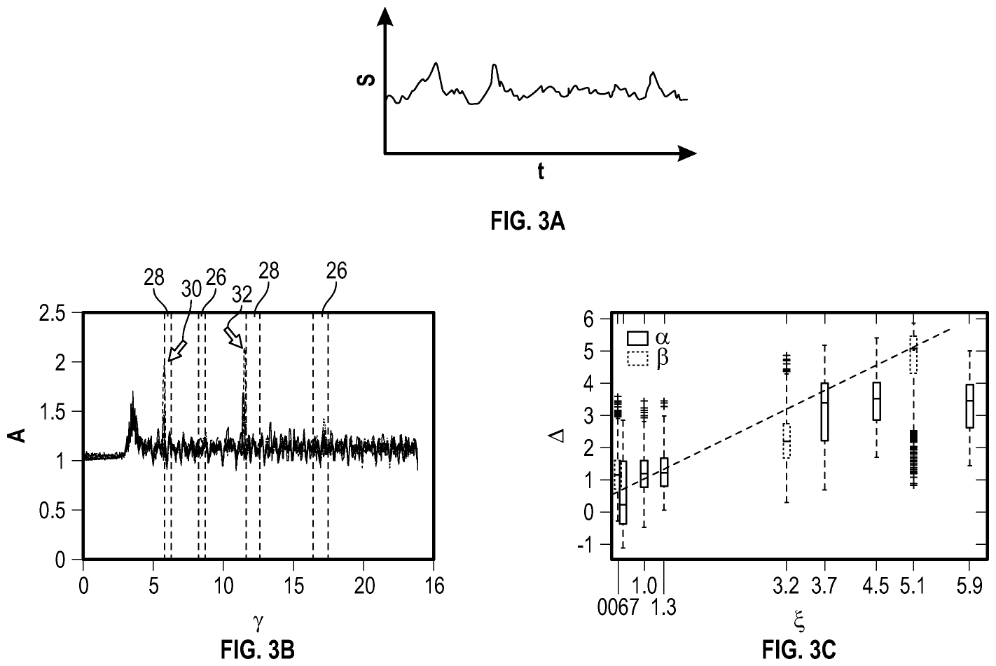

During the operation of the motor vehicle, the sensor 16 produces a wheel speed (S) versus time (t) signal as shown in FIG. 3A. This data (2) along with pulse counter signals (1) are transmitted to the phase domain transform module 118. Other vehicle signals (3), such as, associated with vehicle speed, braking, and steering wheel angle (SWA) are transmitted to the phase domain transform module 118, as well. The data acquisition of these signals (1), (2) and (3) sets the enabling conditions that are met to allow health indication generation for the bearing 13. More specifically, the first enabler 120 identifies signals that are sufficient for bearing health assessment, enabling only those signals that meet conditions on the driving maneuvers.

The phase domain transformed wheel speed is transmitted to the high-pass filter 102, which determines a filter type and cutoff frequency. The vehicle speed, steering data, brake data, such as, brake torque and axle torque data are transmitted to the first enabler 120. Data from high-pass filter 102 and the enabler 120 are combined and transmitted to the STFT 122. Information from the STFT 122 is combined with data, such as, estimated road roughness, from the second enabler 124, which, in turn, is transmitted to the integer order filter 126.

From the pre-processing components, data is then transmitted to the spectrum filter 128 of the post-processing components. The spectrum filter 128 provides a summary spectrum of the wheel speed signal by filtering together multiple spectra calculated on different windows of the wheel speed signal. Further, the spectrum normalization 130 determines the peak height of the analysis from the pre-processing components, the module 132 determines the harmonics of the bearing critical frequencies to utilize for calculating the bearing fault signature, and the module 134 performs a regression analysis of the data from the module 132. Finally, output of the post-processing components provides a bearing fault signature 136 at critical frequencies to indicate the health of the bearing 13. The bearing fault signature 136 is an estimate of the bearing ground-truth state of health, for example, the estimated G-RMS vibration of the bearing 13 or the estimated maximum Brinell depth of the bearing 13.

Referring to FIG. 3B, there is shown an output of the pre-processing components, namely, normalized peak height (A) as outputted by spectrum normalization 130 versus rotational order (y), measured in counts per rotation of the wheel. The bands for the first two harmonics of ball pass frequency outer are identified by reference number 28 and the bands for ball pass frequency inner are identified by reference number 26. Further, FIG. 3B shows the peak frequencies 30 and 32 in the ball pass frequency outer bands 28. Shown in FIG. 3C, an example output of the fault signature from the post-processing components are illustrated as a graph of bearing fault signature (Δ) versus bearing ground truth vibration (ξ) for training data (α) and validation data (β).

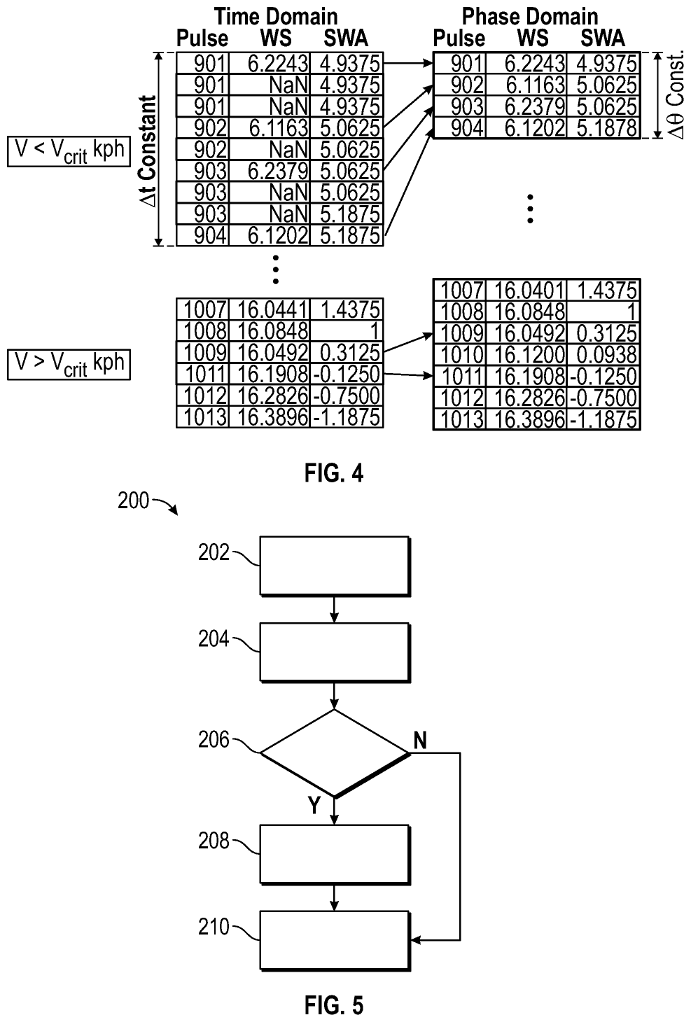

Turning now to FIG. 4, an example output from the phase domain transform module 118 is shown. The left set of tables (At constant) represent data in the time domain for the angle of the brake rotor 12 (pulse), that is, the wheel hub assembly, the wheel speed (WS), and the angle of the steering wheel (SWA). The right set of tables (Δθ constant) represent the data transformed from the time domain to the phase domain. Since the fault signature frequencies of the bearing 13 are sensitive to rotational speed, the phase domain transform 118 normalizes these effects by converting the analysis to the phase domain, in which sampling is independent of speed. As such, the data is evenly spaced by the angle of the brake rotor 12 (that is, the pulse) and not time. There is a critical speed at which new pulses are read by the encoder 14 at the same rate as the sampling of the data. More specifically, when the wheel speed is less than a critical wheel speed (V<Vcrit), new pulses are read at a slower rate so that down-sampling obtains one data point per phase. And when the wheel speed is greater than the critical wheel speed (V>Vcrit), new pulses are read at a higher rate so that interpolation fills in skipped phase values.

Turning to FIG. 5, there is shown a process 200 for adapted STFT for partially enabled signals with the STFT module 122. The process 200 provides a data-efficient frequency analysis for successful fault detection. The process 200 analyzes the frequency content of disjoint segments of the enabled data, for example, different segments of the wheel speed (S) versus time (t) shown in FIG. 3A. In step 202, the process 200 collects an enabled wheel speed (WS) segment. The segments are variable in length as determined by the first enabler 120, depending on the driving maneuvers of the motor vehicle and the pass/fail enabled condition determined by the first enabler 120. In step 204, the WS is multiplied by a windowing function g(t). In decision step 206, the process 200 determines if the WS signal is less than a specified number of samples (N) to include in the STFT. If the determination is no, the process 200 computes the WS fast Fourier transform spectrum in step 210. If the determination from the decision step 206 is yes, the process proceeds to step 208 to extend the signal with zero padding. From step 208, the process 200 proceeds to step 210 to compute the WS fast Fourier transform.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for early detection and prognosis of wheel bearing faults in a motor vehicle, the method comprising:
obtaining a wheel speed of a wheel with a sensor in combination with an encoder ring, the sensor generating a signal, the wheel including a bearing that enables rotational movement of the wheel;
pre-processing the signal from the sensor; and
post-processing an output of the pre-processed signal to generate a bearing fault signature of the bearing.

2. The method of claim 1, wherein pre-processing the signal from the sensor includes a phase domain transformation.

3. The method of claim 1, wherein pre-processing the signal from the sensor includes filtering the signal.

4. The method of claim 1, wherein pre-processing the signal from the sensor includes identifying signals that are sufficient for bearing health assessment.

5. The method of claim 1, wherein pre-processing the signal includes short time Fourier transformation (STFT).

6. The method of claim 5, wherein output from the STFT is combined with output from an enabler.

7. The method of claim 1, wherein post-processing generates a normalized wheel speed frequency spectrum.

8. The method of claim 7, wherein the normalized wheel speed frequency spectrum identifies the bearing fault signature at critical frequencies related to the geometry of the bearing including at least one of the ball pass frequency outer, ball pass frequency inner, and ball spin frequency.

9. The method of claim 1, wherein post-processing includes at least one of spectrum filtering, spectrum normalization, ball critical frequency harmonics analysis, and regression analysis.

10. A method for early detection and prognosis of bearing faults in a rotational member, the method comprising:
obtaining a rotational speed of the rotational member with a sensor in combination with an encoder ring, the sensor generating a signal, the rotational member including a bearing that enables rotational movement of the wheel;
pre-processing the signal from the sensor, pre-processing the signal from the sensor including a phase domain transformation and a short time Fourier transformation (STFT); and
post-processing an output of the pre-processed signal to generate a bearing fault signature of the bearing, post-processing generating a normalized rotational speed frequency spectrum, the normalized rotational speed frequency spectrum identifying the bearing fault signature at critical frequencies.

11. The method of claim 10, wherein pre-processing the signal from the sensor includes filtering the signal.

12. The method of claim 10, wherein pre-processing the signal from the sensor includes identifying signals that are sufficient for bearing health assessment.

13. The method of claim 10, wherein output from the STFT is combined with output from an enabler.

14. The method of claim 10, wherein the normalized wheel speed frequency spectrum is associated with the geometry of the bearing.

15. The method of claim 10, wherein post-processing includes at least one of spectrum filtering, spectrum normalization, ball critical frequency harmonics analysis, and regression analysis.

16. A system for early detection and prognosis of wheel bearing faults in a motor vehicle, the system comprising:
a bearing positioned on the wheel, the bearing enabling rotational movement of the wheel;
an encoder ring positioned on the wheel;
a sensor positioned proximal to the wheel, the sensor in combination with the encoder ring detecting a wheel speed of the wheel;
a controller in communication with the sensor, the controller including instructions to:
pre-process the signal from the sensor, pre-processing the signal from the sensor including a phase domain transformation and a short time Fourier transformation (STFT); and
post-process the pre-processed signal to generate a bearing fault signature of the bearing, post-processing generating a normalized wheel speed frequency spectrum, the normalized wheel speed frequency spectrum identifying the bearing fault signature at critical frequencies.

17. The system of claim 16, wherein output from the STFT is combined with output from an enabler.

18. The system of claim 16, wherein the normalized wheel speed frequency spectrum is associated with the geometry of the bearing.

19. The system of claim 10, wherein post-processing includes at least one of spectrum filtering, spectrum normalization, ball critical frequency harmonics analysis, and regression analysis.
